(19) United States
(12) Patent Application Publication
(10) Pub. No.: US 2003/0100792 A1
(43) Pub. Date: May 29, 2003

(54) Process for preparing arylboron and alkylboron compounds in microreactors

(75) Inventors: Manfred Koch, Eppstein-Niederjosbach (DE); Detlef Wehle, Brechen (DE); Stefan Scherer, Buttelborn (DE); Klaus Forstinger, Babenhausen (DE); Andreas Meudt, Florsheim-Weilbach (DE); Volker Hessel, Hunstetten (DE); Bernd Werner, Pfungstadt (DE); Holger Lowe, Oppenheim (DE)

Correspondence Address: CLARIANT CORPORATION, INTELLECTUAL PROPERTY DEPARTMENT, 4000 MONROE ROAD, CHARLOTTE, NC, 28205, US

(73) Assignee: Clariant GmbH

(21) Appl. No.: 10/210,807

(22) Filed: Aug. 1, 2002

(30) Foreign Application Priority Data
Aug. 21, 2001 (DE) 10110857.9

(51) Int. Cl. C07F 5/02

(52) U.S. Cl. 562/7; 564/9; 568/1; 260/665 G

(57) ABSTRACT

Process for preparing arylboron and alkylboron compounds of the formulae (II) and (III) by reacting arylmagnesium and alkylmagnesium halides of the formula (I) with boron compounds in microreactors in accordance with equation I or equation II,

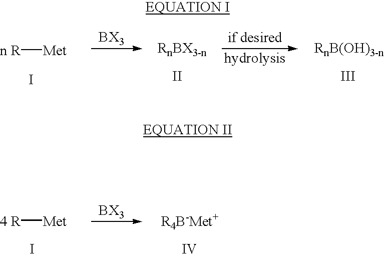

where X=identical or different radicals

Met=MgY where Y=fluorine, chlorine, bromine or iodine,

n=1, 2 or 3,

and R=straight-chain or branched C₁-C₆-alkyl, a substituted C₁-C₆-alkyl or

substituted or unsubstituted 6-membered heteroaryl containing one or two nitrogen atoms, or 5-membered heteroaryl containing one or two heteroatoms or

a substituted or unsubstituted bicyclic or tricyclic aromatic,

in coolable/heatable microreactors whose outlet channels are, if necessary, connected to capillaries or flexible tubes which are a number of meters in length, with the reaction solutions being intensively mixed during a sufficient residence time.

The invention relates to a process for preparing arylboron and alkylboron compounds (II) and (III) by reacting arylmagnesium and alkylmagnesium halides (I) with boron compounds in microreactors in accordance with equation I or equation II,

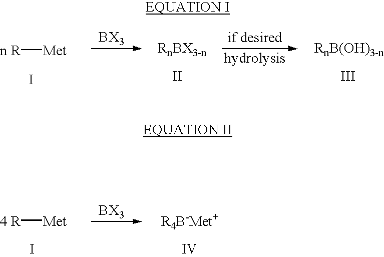

where X=identical or different radicals selected from the group consisting of fluorine, chlorine, bromine, iodine, C₁-C₅-alkoxy, N,N-di(C₁-C₅-alkyl)amino and (C₁-C₅-alkyl)thio,

Met=MgY where Y=fluorine, chlorine, bromine or iodine,

n=1, 2 or 3,

and R=straight-chain or branched C₁-C₆-alkyl, C₁-C₆-alkyl substituted by a radical selected from the group consisting of RO, RR′N, phenyl, substituted phenyl, fluorine and RS, phenyl, phenyl substituted by a radical selected from the group consisting of C₁-C₆-alkyl, C₁-C₆-alkoxy, C₁-C₅-thioether, silyl, fluorine, chlorine, dialkylamino, diarylamino and alkylarylamino, 6-membered heteroaryl containing one or two nitrogen atoms, 5-membered heteroaryl containing one or two heteroatoms selected from the group consisting of N, O and S or a substituted or unsubstituted bicyclic or tricyclic aromatic.

Arylboron and alkylboron compounds have in recent years become very versatile synthetic building blocks whose use, e.g. in Suzuki coupling, makes it possible to prepare many economically very interesting fine chemicals, especially for the pharmaceuticals and agrochemicals industries. Mention may be made first and foremost of arylboronic and alkylboronic acids for which the number of applications in the synthesis of active compounds has increased exponentially in recent years. However, diarylborinic acids are also of increasing importance, for example as cocatalysts in the polymerization of olefins or as starting material in Suzuki couplings in which both aryl radicals can be transferred.

The conversion of aryl Grignard and alkyl Grignard compounds into alkylboron and arylboron compounds has been described in many publications and proceeds in good yields when reaction conditions which are very precisely optimized for the particular case are strictly adhered to.

However, the fact that a wide range of by-products can be formed in amounts which are strongly dependent on the reaction conditions employed is a disadvantage. In principle, possible products after hydrolysis of the reaction mixtures include not only the homocoupling products, i.e. the corresponding biaryls or bialkyls, but also boronic acids, borinic acids, triarylboranes and trialkylboranes and tetraarylboranates or tetraalkylboranates. Apart from the latter charged compounds, the desired reaction products can in each case only be separated off by means of complicated purification operations which reduce the yield and significantly increase the production costs for the products.

In the case of the preparation of arylboronic or alkylboronic acids, the following applies, for example: since there is here a risk of formation of biaryls or bialkyls, borinic acids, boranes and even boranates in which two, three or four equivalents of the organometallic reagent can be consumed, the yield can be decreased severely for this reason when optimum conditions are not adhered to. In many cases, small yields of difficult-to-purify crude products are obtained. A similar situation applies in the preparation of borinic acids, boranes and boranates.

To avoid the abovementioned secondary reactions, the reaction has to be carried out at low temperatures so as to protect the primary products formed in the primary reaction, in the case of the preparation of boronic acids the arylboranates or alkylboranates (V), from decomposition into the free boronic esters or halides (VI),

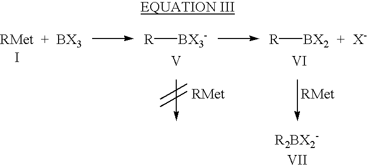

since the latter compete with unreacted BX₃ for further organometallic compound (I) and can thus cause by-product formation and decreases in yield. A very similar situation also occurs in the preparation of more highly alkylated or arylated boron compounds (EQUATION III).

Ideal reaction temperatures are below −20° C., but good results are obtained only at below −35° C. and pure boron compounds and virtually no by-products are obtained at temperatures below −55° C. These temperatures can no longer be achieved industrially by means of cheap cooling methods such as brine cooling, but instead have to be generated at high cost with high energy consumption. Combined with, for example, the preparation of the Grignard reagent which is generally carried out at reflux temperature and the work-up which usually involves removal of the solvent by distillation, this results in a rather uneconomical, high-cost process in which the following temperature sequence has to be employed: room temperature -≦ reflux (Grignard preparation) -≦ cooling -≦ low temperature (preparation of boronic acid) -≦ room temperature (hydrolysis) -≦ boiling temperature (removal of solvent) -≦ cooling (filtration or extraction).

Furthermore, it is always necessary to employ an excess of the usually expensive BX₃. In process engineering terms, apart from extremely low temperatures, it is necessary to place BX₃ in the reactor and to add the solution of the Grignard compound very slowly dropwise, and this solution should also be added in cooled form. A further factor affecting success is the use of relatively dilute solutions, as a result of which only low space-time yields can be achieved.

There is therefore a need to have a process for preparing arylboron and alkylboron compounds which still employs alkyl Grignard and aryl Grignard compounds and boron compounds BX₃ as raw materials and in which the reaction temperatures are, ideally, above −30° C., and high concentrations of the reactants can be employed without, as in the case of classical process engineering approaches, large amounts of the abovementioned by-products being formed, but which at the same time still gives very high yields of pure boron compounds. Despite numerous efforts, it has not hitherto been possible to find appropriate reaction conditions.

The present invention achieves all these objects and provides a process for preparing arylboron and alkylboron compounds of the formulae (II) and (III) by reacting arylmagnesium and alkylmagnesium halides of the formula (I) with boron compounds in microreactors in accordance with equation I or equation II,

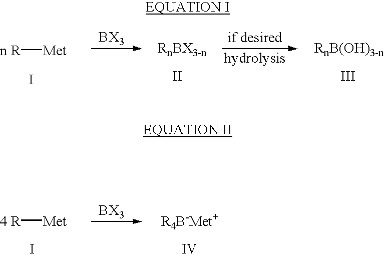

where X=identical or different radicals selected from the group consisting of fluorine, chlorine, bromine, iodine, C₁-C₅-alkoxy, N,N-di(C₁-C₅-alkyl)amino and (C₁-C₅-alkyl)thio,

Met=MgY where Y=fluorine, chlorine, bromine or iodine,

n=1, 2 or 3,

and R=straight-chain or branched C₁-C₆-alkyl, C₁-C₆-alkyl substituted by a radical selected from the group consisting of RO, RR′N, phenyl, substituted phenyl, fluorine and RS, phenyl, phenyl substituted by a radical selected from the group consisting of C₁-C₆-alkyl, C₁-C₆-alkoxy, C₁-C₅-thioether, silyl, fluorine, chlorine, dialkylamino, diarylamino and alkylarylamino or

substituted or unsubstituted 6-membered heteroaryl containing one or two nitrogen atoms, e.g. pyridine, picoline, pyridazine, pyrimidine or pyrazine, or

5-membered heteroaryl containing one or two heteroatoms selected from the group consisting of N, O and S, e.g. pyrrole, furan, thiophene, imidazole, oxazole or thiazole, or

a substituted or unsubstituted bicyclic or tricyclic aromatic, e.g. naphthalene, anthracene or phenanthrene,

in coolable/heatable microreactors, in particular in combination with a micromixer, whose outlet channels are, if necessary, connected to capillaries or flexible tubes which are a number of meters in length, with the reaction solutions being intensively mixed during a sufficient residence time.

The work-up of the combined reaction mixtures can be carried out by “classical” work-up and hydrolysis methods.

According to the invention, this process can be carried out continuously.

To carry out the process of the invention, it is possible to use, in particular, flow-through reactors whose channels have a diameter of from 25 microns to 2 000 microns, in particular from 40 microns to 1300 microns. The flow rate is set so as to give a residence time which corresponds to a conversion of at least 70%. The flow rate in the microreactor is preferably set so that a residence time in the range from one second to 10 minutes, in particular from 10 seconds to 5 minutes, is achieved.

Preference is given to using reactors which can be produced by means of technologies employed in the production of silicon chips. However, it is also possible to use comparable reactors which are produced from other materials which are inert toward the Grignard solutions and the boron compounds, for example granite, ceramic or glass or metallic materials, such as stainless steel or Hastelloy. The microreactors are preferably produced by joining thin silicon structures to one another.

In selecting the miniaturized flow-through reactors to be used, it is important to adhere to the following parameters:

The reaction mixture has to be approximately uniformly mixed in each volume element

The channels have to be sufficiently wide for unhindered flow to be possible without undesirable pressure building up

The structure of the microreactors in combination with the flow rates set has to make possible a residence time which is sufficient to allow a minimum conversion

The system comprising microreactor and discharge tubes has to be able to be cooled and heated.

The conversions according to the invention are advantageously carried out at temperatures of from −60° C. to +80° C., preferably from −50° C. to +60° C., particularly preferably from −40° C. to +40° C.

It is found that the optimum mixing which can be achieved in the microreactors used leads to the very remarkable result that the amount of the abovementioned by-products present in the resulting boron compounds is virtually independent of the reaction temperature. Typical amounts of the by-products mentioned in the boron compounds prepared are, in the case of the preparation of boronic acids, from 0.1 to 4.0% of borinic acid, <1% of borane and <1% of boranates, but significantly higher purities are usually obtained, with boronic acid contents of <2%, borane contents of <1% and boranate contents of <0.5% being measured. Such selectivities cannot be achieved when using a “classical process engineering technique” even at low temperatures.

The work-up is very simple because product purification is no longer necessary. Even in the case of applications having very high purity requirements, the boron compounds obtained can be used directly. A preferred work-up method is, for example, introducing the reaction mixtures into water, acidifying the mixture with mineral acid, distilling off the solvent or solvents and filtering off the pure boron compounds.

In the process of the invention for preparing arylboronic acids, it is possible to achieve, for example, product purities of >99% and yields of >95% in this way.

Suitable solvents for the method of preparing boron compounds according to the invention are aliphatic and aromatic ethers and hydrocarbons and amines which bear no hydrogen on the nitrogen, preferably triethylamine, diethyl ether, tetrahydrofuran, toluene, toluene/THF mixtures, anisole and diisopropyl ether, particularly preferably toluene, THF or diisopropyl ether.

Preference is given to solutions having concentrations in the range from 1 to 35% by weight, in particular from 5 to 30% by weight, particularly preferably from 8 to 25% by weight.

The process of the invention is illustrated by the following examples without being restricted thereto:

### EXAMPLE 1

Preparation of Phenylboronic Acid From Phenylmagnesium Chloride and Trimethyl Borate

Use was made of a) a solution of phenylmagnesium chloride in THF, c=0.5 mol/l, and b) a solution of trimethyl borate in THF, c=0.5 mol/l. The micromixer used was a single micromixer comprising 25×300 μm and 40×300 μm nickel structures on a copper backing from the Institut fur Mikrotechnik Mainz. A residence time of 10s was set in the first experiment. The two solutions and the microreactor were maintained at a temperature of 0° C. After the apparatus had been thoroughly flushed with a total of 1.5 l of THF (water-free), a total of 2 l of each starting solution were fed in. The reaction mixture obtained was collected and was concentrated by pouring into water (330 ml), adjusting the pH to 4.5 and subsequently gently distilling off the THF at 200 mbar. Cooling to 0° C., filtration and drying of the product at 40° C./100 mbar gave 116.3 g of phenylboronic acid (0.955 mol, 95.5%) having a purity of 99.2% (HPLC a/a, borinic acid content=0.6%, triphenylborane not detectable).

The reaction product can be converted quantitatively into the trimeric anhydride triphenylboroxin by drying for 5 hours at 75° C./0.5 mbar. Exactly the calculated amount of water is given off during this procedure.

### EXAMPLES 2 to 4

Phenylboronic Acid From PhMgCl and B(OMe)₃—Variation of the Temperature

| | T (starting | Yield of | HPLC | Borinic acid |
|---|---|---|---|---|
| | materials, | product | a/a | content |
| Experiment | reactor | isolated | (purity) | HPLC a/a |
| 2 | −20° C. | 94.4% | 98.9% | 0.6% |
| 1 | 0° C. | 95.5% | 99.2% | 0.8% |
| 3 | +15° C. | 95.1% | 99.0% | 0.7% |
| 4 | +30° C. | 94.7% | 98.9% | 0.6% |

No discernible temperature dependence in the temperature range examined.

### EXAMPLES 5 to 8

Phenylboronic Acid From PhMgCl and B(OMe)₃—Variation of the Residence Times

| | T (starting | | Yield of | | Borinic acid |
|---|---|---|---|---|---|
| Experi- | materials, | Residence | product | HPLC a/a | content |
| ment | reactor) | time | isolated | (purity) | HPLC a/a |
| 5 | 20° C. | 5 s | 94.9% | 98.9% | 0.6% |
| 6 | 20° C. | 60 s | 93.9% | 99.1% | 0.8% |
| 7 | 20° C. | 120 s | 95.7% | 98.9% | 1.1% |
| 8 | 20° C. | 180 s | 94.8% | 98.5% | 1.3% |

Examination of the table reveals the following trend: the shorter the residence time, the higher the selectivity (=the higher the flow rate, the higher the selectivity)

### EXAMPLE 9

Phenylboronic Acid From PhMgCl and B(OMe)₃—Variation of the Concentration

| | | | | | | Borinic |
|---|---|---|---|---|---|---|
| | T (starting | Concentration | | Yield of | HPLC | acid |
| Experi- | materials, | of starting | Residence | product | a/a | content |
| ment | reactor) | materials | time | isolated | (purity) | HPLC a/a |
| 5 | 20° C. | 0.5 mol/l | 5 s | 94.9% | 98.9% | 0.6% |
| 9 | 20° C. | 1 mol/l | 5 s | 93.7% | 98.4% | 1.1% |

Examination of the table reveals the following trend: the higher the concentration, the lower the selectivity, but the effect is not as strongly pronounced compared to the improvement potential possible by means reaction technology (cf. comparative experiment 10).

### EXAMPLE 10

“Classical” Reaction Procedure

The solutions of a) phenylmagnesium chloride in THF, c 0.5 mol/l, T=20° C., and b) trimethyl borate in THF, c=0.5 mol/l, T=20° C., were reacted by introducing the trimethyl borate solution and the Grignard solution simultanteously into a round-bottom flask maintained at 20° C. The solutions were introduced at such a rate that the temperature could be held at (20±5)° C. (22 min for a total volume of 1.5 I). A total yield of 83% (including by-products) was obtained, and HPLC analysis indicated a borinic acid content of 13.8% and a triphenylborane content of 1.1% (in each case a/a).

### EXAMPLES 11 to 13

Phenylboronic Acid From PhMgHal and BX₃—Variation of Hal and X (Conditions: T (Starting Materials, Reactor)=20° C.; Residence Time=5 s)

| | | | Yield of | HPLC | Borinic acid |
|---|---|---|---|---|---|
| Experi- | | | product | a/a | content |
| ment | Hal | X | isolated | (purity) | HPLC a/a |
| 5 | Cl | OMe | 94.9% | 98.9% | 0.6% |
| 11 | Br | OMe | 93.9% | 98.7% | 0.9% |
| 12 | Cl | F (as BF₃ × Et₂O) | 73.2% | 96.9% | 2.1% |
| 13 | Cl | OiPr | 84.5% | 97.1% | <0.1% |

### EXAMPLE 14

4-Tolylboronic Acid From pTolMgCl and B(OEt)₃

Conditions: T (starting materials, reactor)=20° C.; residence time=5 s, c (starting solutions in THF)=0.75 mol/l. The collected organic phases were poured into water, the pH was adjusted to 4.5 by means of 20% sulfuric acid, the solvent was distilled off at 100 mbar and the product was isolated by filtration at 5° C. 4-Tolylboronic acid was obtained in a yield of 92%; the ditolylboronic acid content was only 0.4% (HPLC a/a) and tritolylborane was not detectable.

### EXAMPLES 15 to 19

Boronic Acids From RMgCI and B(OMe)₃

Conditions: T (starting materials, reactor)=20° C.; residence time=5 s, c (starting solutions in THF)=0.75 mol/l nt R Yield of product HPLC a/a Borinic acid isolated (purity) content

| | | Yield of | | |
|---|---|---|---|---|
| | | product | HPLC a/a | Borinic acid |
| Experiment | R | isolated | (purity) | content |
| 15 | 4-CF₃-Ph | 92.2% | 98.9% | 0.8% |
| 16 | 3-F-Ph | 90.8% | 98.7% | 0.4% |
| 17 | 4-biphenyl-4'-yl | 89.1% | 96.9% | <0.1% |
| 18 | 4-MeO-Ph | 91.2% | 97.8% | 0.8% |
| 19 | iPr | 71.5% | 95.2%* | 1.3% |

*Analysis by GC after conversion into the pinacol derivative, all figures in percent by area.

### EXAMPLE 20

Preparation of Diphenylborinic Acid

Diphenylborinic acid can be prepared by a procedure analogous to that described in example 1 when a) a solution of phenylmagnesium chloride in THF, c=1.0 mol/l, and b) a solution of trimethyl borate in THF, c=0.5 mol/l, are reacted in the microreactor described in example 1. The work-up is carried out in the manner which has already been described a number of times by pouring into water, adjusting the pH to 6.0 (hydrolysis sensitivity of borinic acids!) and distilling off the solvent under mild conditions. After filtration and drying, diphenylborinic acid is obtained in a yield of 88% (based on trimethyl borate), HPLC purity: 97.1%, by-product content: phenylboronic acid 1.1%, triphenylborane 0.4% (in each case HPLC a/a).

### EXAMPLE 21

Preparation of Triphenylborane

Triphenylborane can be prepared analogously by reacting a) a solution of phenylmagnesium chloride in THF, c=1.0 mol/l, and b) a solution of trimethyl borate in THF, c=0.33 mol/l, in the microreactor which has been described a number of times. The work-up is carried out in the above-described manner by pouring into water, adjusting the pH to 6.0 and distilling off the solvent under mild conditions. After filtration and drying, triphenylborane is obtained in a yield of 88% (based on trimethylborate), HPLC purity: 97.1%, by-product content: phenylboronic acid 1.1%, diphenylborinic acid 0.4% (in each case HPLC a/a).

1. A process for preparing arylboron and alkylboron compounds of the formulae (II) and (III) by reacting arylmagnesium and alkylmagnesium halides of the formula (I) with boron compounds in microreactors in accordance with equation I or equation II, 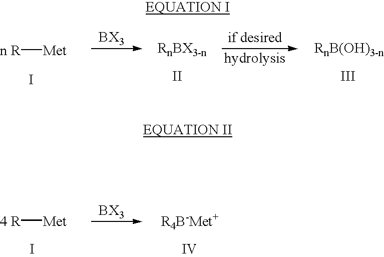
where X=identical or different radicals selected from the group consisting of fluorine, chlorine, bromine, iodine, C₁-C₅-alkoxy, N,N-di(C₁-C₅-alkyl)amino and (C₁-C₅-alkyl)thio,
Met=MgY where Y=fluorine, chlorine, bromine or iodine,
n=1, 2 or 3,
and R=straight-chain or branched C₁-C₆-alkyl, C₁-C₆-alkyl substituted by a radical selected from the group consisting of RO, RR′N, phenyl, substituted phenyl, fluorine and RS, phenyl, phenyl substituted by a radical selected from the group consisting of C₁-C₆-alkyl, C₁-C₆-alkoxy, C₁-C₅-thioether, silyl, fluorine, chlorine, dialkylamino, diarylamino and alkylarylamino or
substituted or unsubstituted 6-membered heteroaryl containing one or two nitrogen atoms, or 5-membered heteroaryl containing one or two heteroatoms selected from the group consisting of N, O and S, or a substituted or unsubstituted bicyclic or tricyclic aromatic,
in coolable/heatable microreactors whose outlet channels are, if necessary, connected to capillaries or flexible tubes which are a number of meters in length, with the reaction solutions being intensively mixed during a sufficient residence time.

2. The process as claimed in claim 1, wherein the microreactors used are flow-through reactors whose channels have a diameter of from 25 to 2000 microns.

3. The process as claimed in claim 1, wherein the flow rate in the microreactor is set so that a residence time of from one second to 10 minutes is achieved.

4. The process as claimed in claim 1, wherein the reaction is carried out at temperatures in the range from −60° C. to +80° C.

5. The process as claimed in claim 1, wherein solutions having a concentration in the range from 1 to 35% by weight are used.

6. The process as claimed in claim 1, wherein microreactors are used in combination with a micromixer.

7. The process as claimed in claim 2, wherein the flow rate in the microreactor is set so that a residence time of from one second to 10 minutes is achieved.

8. The process as claimed in claim 2, wherein the reaction is carried out at temperatures in the range from −60° C. to +80° C.

9. The process as claimed in claim 2, wherein solutions having a concentration in the range from 1 to 35% by weight are used.

10. The process as claimed in claim 2, wherein microreactors are used in combination with a micromixer.

12. The process as claimed in claim 3, wherein the reaction is carried out at temperatures in the range from −60° C. to +80° C.

13. The process as claimed in claim 3, wherein solutions having a concentration in the range from 1 to 35% by weight are used.

14. The process as claimed in claim 3, wherein microreactors are used in combination with a micromixer.

15. The process as claimed in claim 4, wherein solutions having a concentration in the range from 1 to 35% by weight are used.

16. The process as claimed in claim 4, wherein microreactors are used in combination with a micromixer.

17. The process as claimed in claim 5, wherein microreactors are used in combination with a micromixer.
